(19) United States
(12) Patent Application Publication
(10) Pub. No.: US 2023/0076954 A1
(43) Pub. Date: Mar. 9, 2023

(54) A Support And Holding Assembly For A Portable Electronic Device, And A Vehicle Dashboard Provided With This Support And Holding Assembly

(71) Applicant: FCA ITALY S.p.A., (US)

(72) Inventors: Francesco VIOTTI, Torino (IT); Giorgio GAGLIARDONE, Torino (IT)

(21) Appl. No.: 17/890,353

(22) Filed: Aug. 18, 2022

(30) Foreign Application Priority Data
Sep. 7, 2021 (EP) 21195334.4

(51) Int. Cl. B60R 11/02

(52) U.S. Cl. CPC B60R 11/02; B60R 2011/0005

(57) ABSTRACT

A support and holding assembly for a portable electronic device has a support member with a coupling portion at one end to couple the portable electronic device in a reference position; the support member can be moved in relation to a support structure between a withdrawn rest position and an advanced position, when acted on by a first transmission, and carries a retention member that can be moved to and from an engaged position, in which it locks, in use, the portable electronic device in the reference position.

### CROSS-REFERENCE TO RELATED APPLICATIONS

This patent application claims priority from European patent application no. 21195334.4 filed on Sep. 7, 2021, the entire disclosure of which is incorporated herein by reference.

### TECHNICAL FIELD OF THE INVENTION

This invention relates to a support and holding assembly for arranging a portable electronic device in a fixed reference position, in particular in a passenger compartment of a vehicle, to which the following discussion will make explicit reference without losing any generality thereby.

### STATE OF THE ART

In this regard, it is known that portable electronic devices, such as, for example, cellular phones, satellite navigators, tablets, etc., are extremely widespread and are also used in vehicles. In general, the portable electronic device is coupled so that it can be coupled in a releasable manner to a support provided in the passenger compartment. In some solutions, this support is defined by a structure carried by the dashboard of the vehicle. It projects from this dashboard upwards and, in general, has a seat or a jaw where the portable electronic device can be inserted/clamped. In other solutions, the support is defined by a structure that is attached to the windscreen of the vehicle via a suction cup.

The first type of solutions, i.e. the one involving a support that is firmly coupled to the dashboard, is the preferred solution, since it is the safest, both as far as regarding its ensuring against undesired disengagements, and for the fact that it blocks external visibility through the windscreen less.

There is, however, the need to improve this type of solution, in particular to be able to hide or remove the support when the portable electronic device is not coupled to this support, and to facilitate the engagement and disengagement of the portable electronic device, while continuing to ensure a high degree of safety in its positioning and holding.

### SUBJECT AND SUMMARY OF THE INVENTION

The purpose of this invention is to make a support and holding assembly for a portable electronic device, which makes it possible to fulfil, in a simple and economical manner, the requirements described above.

According to this invention, a support and holding assembly for a portable electronic device, as defined in the attached claims from 1 to 14, and a dashboard for a vehicle as defined in claim 15, are provided.

### BRIEF DESCRIPTION OF THE DRAWINGS

This invention will now be described with reference to the attached drawings that illustrate a non-limiting embodiment thereof, in which:

FIG. 1 illustrates, in perspective from below and with parts removed for clarity, a preferred embodiment of the support and holding assembly for a portable electronic device, according to the precepts of this invention;

FIG. 2 is a cross section, according to a plane section defined by the line II-II in FIG. 1;

FIGS. 3 to 6 are similar to FIG. 2 and show an action that, at first, carries the assembly from a withdrawn rest position to an advanced position and, then, locks the portable electronic device in a reference position;

FIG. 7 is a cross section, according to a plane section defined by the line VII-VII in FIG. 1, and corresponds to the operating condition shown in FIG. 6; and

FIG. 8 is similar to FIG. 7 and shows an action that withdraws the support and holding assembly from the advanced position to an operating position.

### DETAILED DESCRIPTION OF PREFERRED EMBODIMENTS OF THE INVENTION

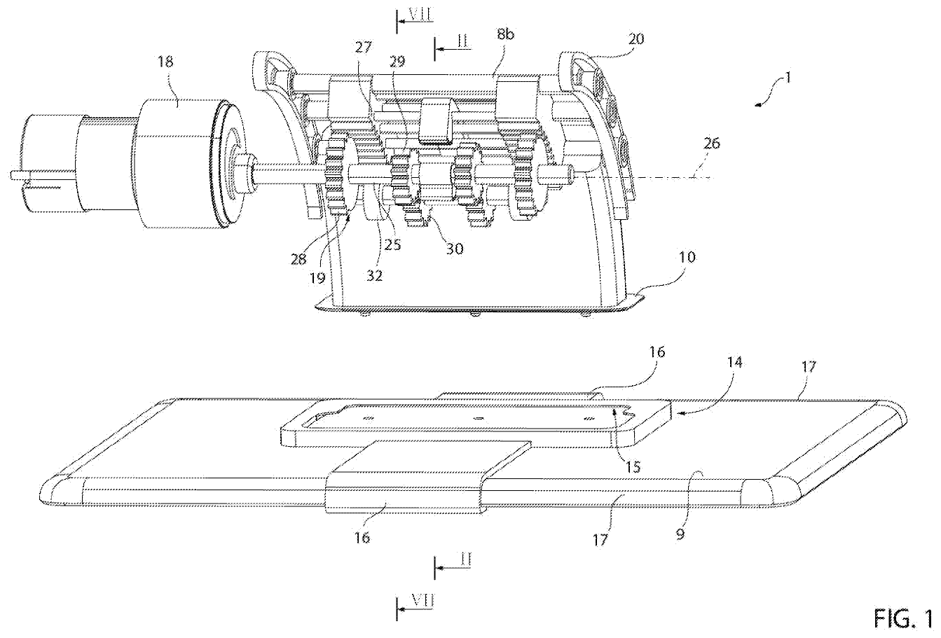

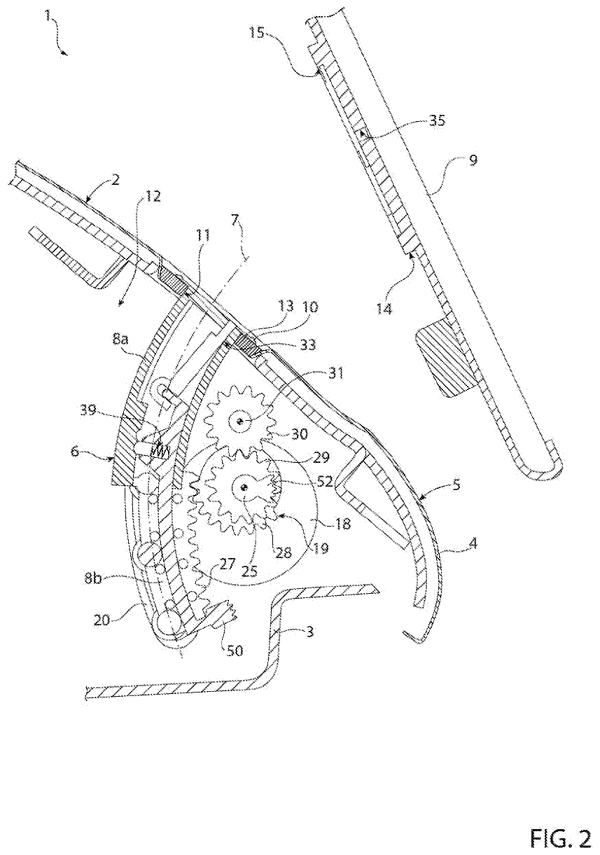

In FIG. 1, the reference number 1 denotes, as a whole, a support and holding assembly (partially illustrated), defining a component that, in the specific described example, is part of a dashboard 2 (partially illustrated in FIGS. 2 to 8) arranged in a passenger compartment of a vehicle.

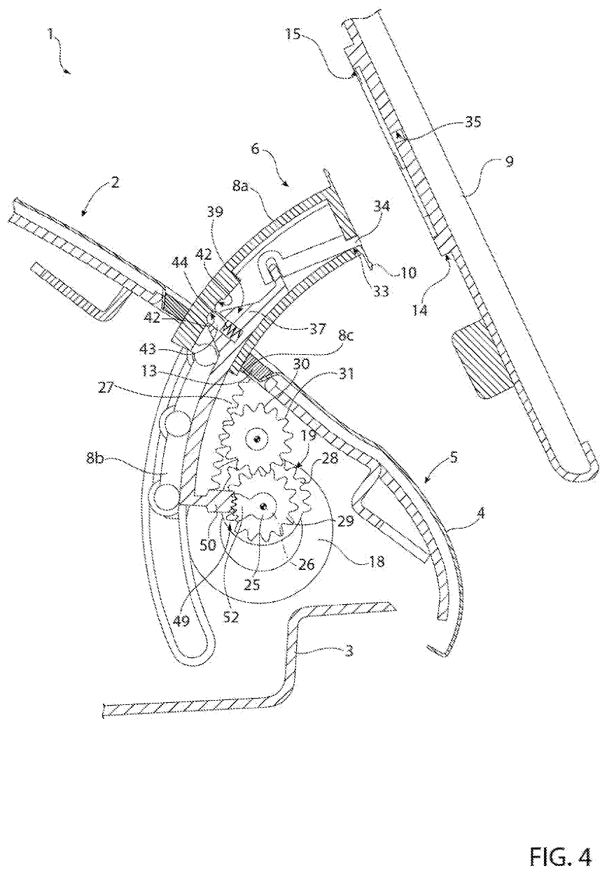

With reference to FIG. 2, the dashboard 2 comprises a support structure 3 and a shell 4 made of plastic, having an outer surface 5 that defines a front area of the passenger compartment. In particular, at least a part of the surface 5 is facing upwards and, therefore, faces a windscreen (not illustrated) of the vehicle. The assembly 1 is fixed to the structure 3 in a manner not described in detail, and comprises a support member 6, which can be moved in relation to the structure 3 between a withdrawn rest position (FIG. 2) and an advanced position (FIG. 4-7).

The member 6 extends along an axis 7 and comprises two portions 8a and 8b, axially opposite each other: the portion 8a has, at one end thereof, a coupling system with a structure, shape, and size that enable the manual coupling of a portable electronic device 9 to the assembly 1, in a reference position. In the particular example illustrated, the coupling system is defined by a flange 10 that is arranged along a perimeter edge of the portion 8a, so as to define a projecting fin that lies on a plane orthogonal to the axis 7.

In the withdrawn rest position, the portion 8a is arranged at a through opening 11 formed in the shell 4. In other words, the portion 8a engages and closes the opening 11, while the member 6 does not project into the passenger compartment, but is hidden in an inner space 12 in the dashboard 2 (except for the flange 10, which is basically flush with the surface 5). In practice, therefore, the member 6 is retractable. In detail, the flange 10 is arranged to rest on a seal 13 that defines the edge of the opening 11 and slides in contact with the lateral surface of the member 6, so as to seal and insulate the space 12 of the passenger compartment.

With reference to FIG. 4, in the advanced position, the portion 8a projects into the passenger compartment, so that the user can easily couple and uncouple the device 9 to the member 6. In the particular example illustrated, the device 9, before being mounted on the member 6, is coupled in a fixed position to an interface element 14, which, in turn, is coupled to the portion 8a. In the particular illustrated example, the interface element 14 comprises at least one seat 15 designed to be engaged by the flange 10 so as to define a bayonet coupling (more specifically: a coupling requiring the device 9 to slide in a direction orthogonal to the axis 7, for example downwards, to engage the flange 10 in the seat 15 and, thus, bringing the device 9 into the above-mentioned reference position).

The interface element 14 is preferably an adapter element, i.e., it is able to adapt to devices 9 with different sizes: for example, with reference to FIG. 1, the interface element 14 comprises two arms 16 that are shaped so as to engage opposite edges 17 of the device 9 and can translate, or be elastically deformed, to adapt to different widths of the device 9 (for example from 10 to 14 inches). The mechanism to modulate the interface element 14 could, however, be different from the configuration just described.

Alternatively, the interface element 14 can be interchangeable with other interfaces that have different sizes and/or shapes, each configured to be coupled with a corresponding electronic device model.

According to not illustrated variants (that could, however, be less desirable in terms of aesthetics), the portion 8a is provided with a coupling system having features that enable direct coupling with the device 9, in a releasable manner, without any interface.

In order to shift between the advanced and withdrawn positions, the assembly 1 comprises an electric motor 18, a transmission 19 for transmitting the movement from the motor 18 to the member 6, and a guide 20, which couples the portion 8b to the structure 3 and enables the member 6 to translate when operated by the motor 18.

In the specific illustrated example, the translation trajectory defined by the guide 20 is parallel to the axis 7. In particular, this trajectory is an arc of a circle, with the concavity facing towards the passenger compartment and/or downwards.

In general, the member 6 coupling mode and the trajectory thereof are of secondary importance: for example, the guide 20 could be replaced by a hinge, lever, or articulated quadrilateral system, or it could be straight, and not curved.

The advanced position and the withdrawn rest position of the member 6 are preferably end-of-stroke positions, defined by corresponding shoulders or stop systems: for example, the stop in the withdrawn rest position is defined by the flange 10 abutting against the seal 13. For the stop in the advanced position, the corresponding stop system may be defined by the abutting of a projection 8c of the member 6, carried, for example, by the portion 8b, against an internal surface of the shell 4 and/or against the same seal 13 (FIG. 4-6).

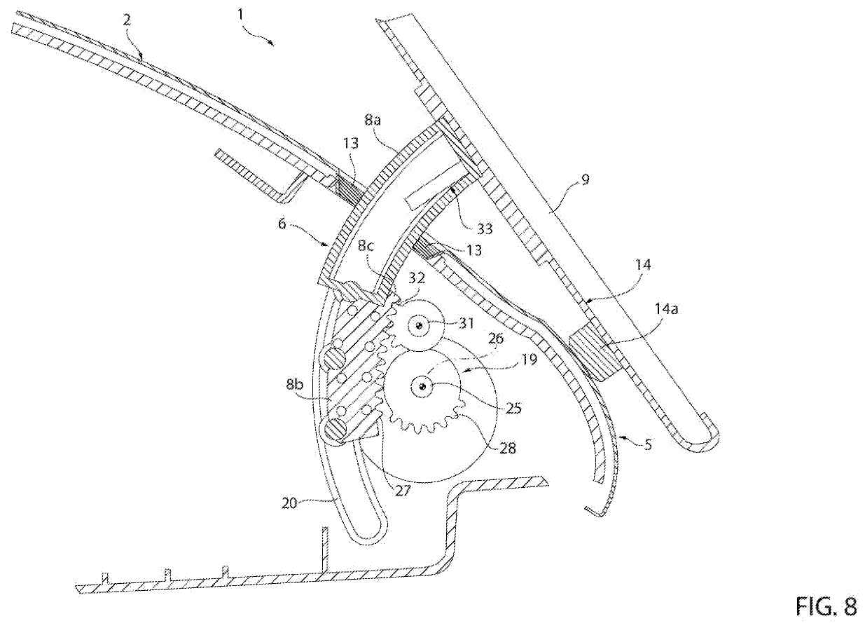

In the normal operating conditions, in which the user observes and uses the device 9, the member 6 is arranged in an operating position (FIG. 8) that does not coincide with the advanced position, in the particular example illustrated, but it is intermediate between the latter and the withdrawn rest position. However, after having coupled the device 9 to the portion 8a, the member 6 is withdrawn until it reaches this operating position, again thanks to the action of the motor 18, as will be better described below. The advanced position, however, is only used to couple, and uncouple, the device 9. The withdrawal in the operating position is envisaged to ensure the correct opening of an airbag device, not illustrated, housed in the dashboard 2 (for example in a zone between the assembly 1 and the windscreen). In any case, according to variants not illustrated, the operating position and the advanced position may coincide (i.e., no withdrawal is envisaged after having mounted the device 9 on the portion 8a).

Again, with reference to FIG. 1, the assembly 1 comprises a motor shaft 25, which is arranged in a fixed position in relation to the structure 3 (for example, it is supported by bearings that are not illustrated) and extends along a horizontal axis 26 distanced from the member 6 (and orthogonal to a longitudinal plane on which the axis lies 7). The shaft 25 rotates around the axis 26 when acted upon by the motor 18.

With reference to FIGS. 1 and 2, the transmission 19 is preferably a toothed transmission comprising:
at least one rack 27, which is fixed in relation to the member 6 and is parallel to the trajectory defined by the guide 20; and
at least one pinion 28, which is carried in a fixed position by the shaft 25 and has a toothing that meshes with the rack 27 only when the member 6 needs to shift from the advanced position to the withdrawn one, and vice versa, while it is disengaged from the rack 27 when the member 6 needs to shift from the advanced position to the operating one, and vice-versa.

The transmission 19 preferably further comprises at least one pair of idler gears 29 and 30: the gear 29 is carried in a fixed position by the shaft 25 and, thus, rotates together with the pinion 28, while the other gear 30 is carried in a fixed position by a transmission shaft 31 parallel to the shaft 25 and engages with the gear 29 so as to rotate the shaft 31 in the opposite direction. At the same time, the shaft 31 is arranged in a fixed position in relation to the structure 3 (for example it is supported by bearings that are not illustrated).

With reference to FIGS. 1 and 8, then, the transmission 19 comprises at least one pinion 32, which is carried in a fixed position by the shaft 31 and has a toothing that engages with the rack 27 only when the member 6 needs to shift from the advanced position to the operating one, and vice-versa, while it is disengaged from the rack 27 when the member 6 needs to shift between the two end-of-stroke positions defined by the advanced position and the withdrawn one.

Therefore, the toothings of the pinions 28 and 32 selectively engage the rack 27, i.e., the one alternates with the other, depending on the rotation angle of the motor 18 and of the shaft 25. In particular, the pinions 28 and 32 have the shape of a toothed wheel without a toothing for a pre-defined angle, established for each project. According to a variant not illustrated, the pinions 28 and 32 could be defined by corresponding toothed segments.

For a certain rotation angle interval of the shaft 25, the rack 27 is preferably disengaged from both the pinions 28 and 32. In this step, the member 6 is arranged in the advanced position (FIGS. 4 to 7) and is preferably held in this position, for example by the above-mentioned stop system not illustrated.

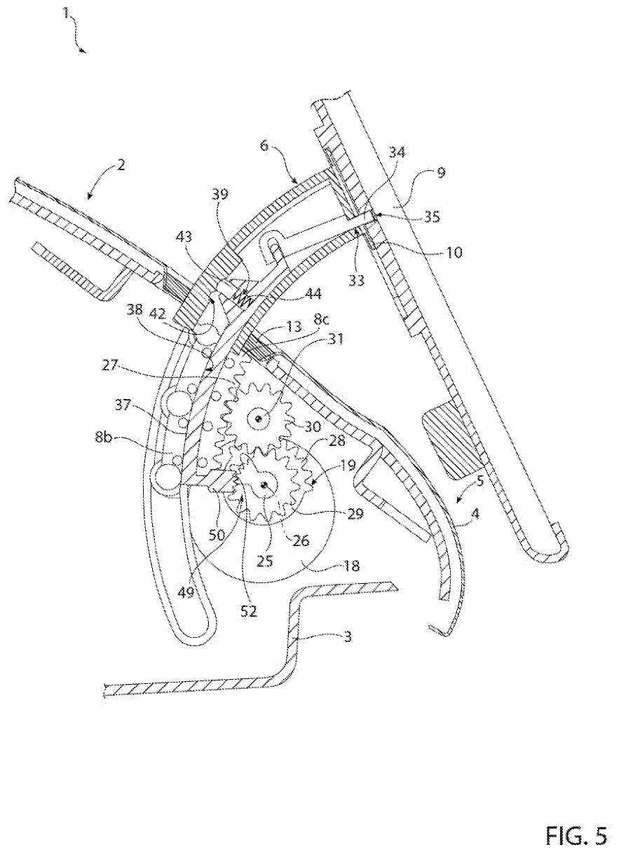

With reference to FIGS. 4 and 5, the assembly 1 further comprises a retention member 33 that is carried by the member 6 and, when the latter is in the advanced position, it is moved to block the device 9 and/or the interface element 14 in the reference position, in order to avoid these components from being accidentally disengaged during use.

The member 33 can be moved in relation to the other member 6 between an engaged position and a disengaged position: in the engaged position (FIG. 5), the member 33 projects from the portion 8a to be coupled with a corresponding shoulder 35 of the device 9 and/or of the interface element 14, and, therefore, to avoid these components from being disengaged; in the disengaged position (FIG. 4), the device 9 and the interface element 14 (if included) can be freely mounted and disassembled. For example, the member 33 comprises at least one tooth or bolt 34 that can slide along the axis 7 to engage/disengage a corresponding seat formed in the interface element 14 and defining the shoulder 35 (in this way, the flange 10 is blocked from sliding in the seat 15).

In particular, the member 33 comprises a slide 37 that carries the tooth 34 to one end thereof and is coupled to the member 6 via a guide 38. In particular, the trajectory defined by the guide 38 is curved (in the example illustrated, it is parallel to the axis 7). More preferably, the guide 38 is arranged at the portion 8b, and an end part of the slide 37 slides inside the portion 8a and, as mentioned above, supports the tooth 34.

The assembly 1 also comprises an attachment and positioning device 39 that exerts a holding force that keeps the member 33 in the engaged and disengaged positions in relation to the member 6. To be able to shift the member 33, a threshold value of this force must be exceeded. The device 39, for example, comprises two retention seats 42 selectively engaged by a retention element 43 (for example with a spherical end), in turn pushed by a spring 44 (with a pretensioning that defines the above-mentioned threshold value). In detail, the retention element 43 and the spring 44 are carried by the retention member 33, in particular by an intermediate portion of the slide 37, while the seats 42 are formed in a wall of the member 6 (but, alternatively, an inverse configuration could be adopted). In each case, the device 39 could be of a different type, for example, it could use friction holding, instead of using the pretensioning of the spring 44 to hold the member 33.

According to one preferred aspect of this invention, the member 33 is also driven by the shaft 25 via a transmission 49. In other words, the assembly 1 has a single motor 18 and a single shaft 25 to shift both the members 6 and 33. Generally, however, alternative solutions, which have a first motor shaft dedicated to driving the member 6 and a second motor shaft dedicated to driving the other member 33, are not excluded.

The motor 18 is preferably permanently coupled to both the transmissions 19 and 49 without using additional clutches or selectors that need to direct the motion to one or the other of these transmissions. The transmission 49 acts in order to translate the member 33 in relation to the other member 6 when the latter is disengaged from the pinions 28 and 32 of the transmission 19, as shown in FIG. 5.

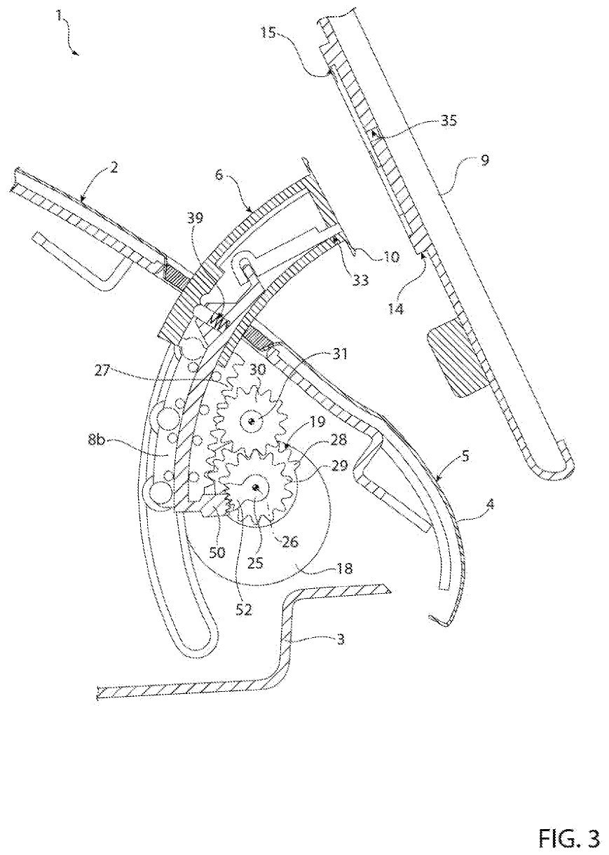

The transmission 49 is a rack and pinion drive and comprises a rack 50, which is fixed in relation to the member 33 and is basically parallel to the trajectory defined by the guide 38. The transmission 49 further comprises a pinion 52 carried in a fixed position by the shaft 25, to drive the rack 50. The pinion 52 is defined by a toothed segment, but, alternatively, it could have the same configuration of the pinions 28 and 32 (toothed wheels without, for a certain angle, toothings). The pinion 52 meshes with the rack 50 when the member 6 is arranged
in the advanced position (FIGS. 4 and 5) and
along a final part of the progress between the two end-of-stroke positions, near the advanced position (i.e., the part of the stroke between FIGS. 3 and 4).

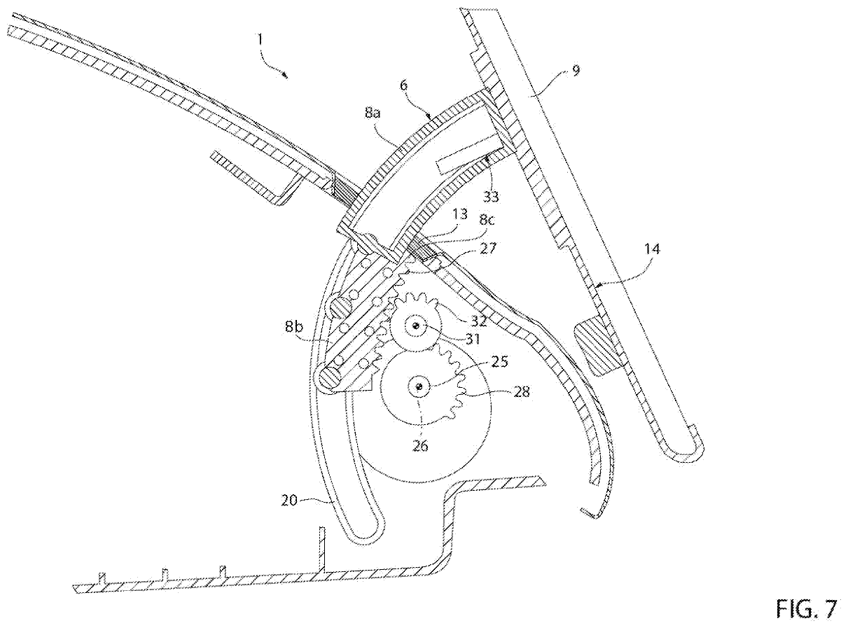

The toothing of the pinion 52 is disengaged from the rack 50:
in the remaining part of the stroke between the two end-of-stroke positions (i.e., the part of the stroke between FIGS. 2 and 3) and
when the member 6 shifts from the advanced position to the operating one, and vice versa (i.e., the stroke envisaged between FIGS. 7 and 8).

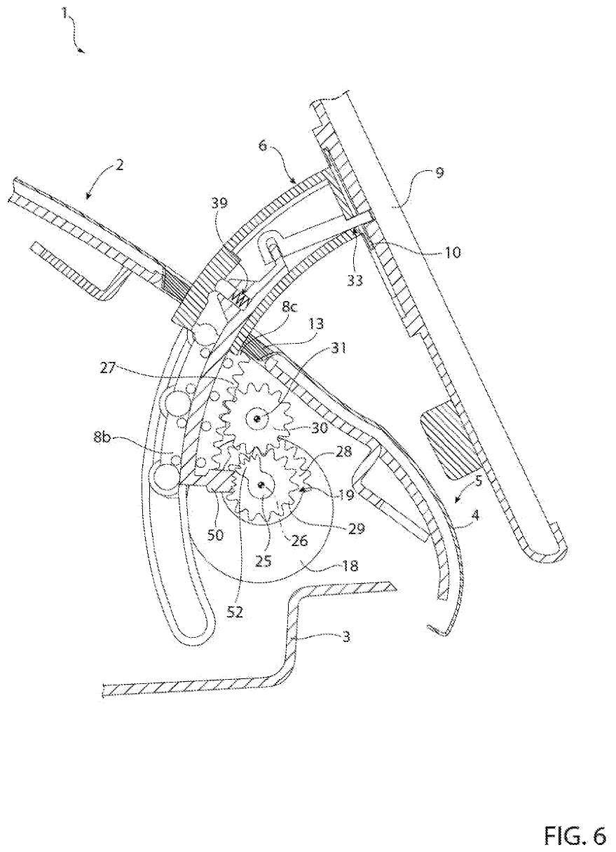

In other words, when the motor 18 is controlled to drive the transmissions 19 and 49, the following steps occur, beginning from the withdrawn rest position in FIG. 2:
1. in the withdrawn position (FIG. 2), the toothing of the pinion 28 meshes with the rack 27; the member 33 is in the release position; the pinions 32 and 52 are disengaged from the racks 27 and 50;
2. by starting the motor 18, the shaft 25 begins to rotate and, thus, the pinion 28 causes the translation of the rack 27; the components 6 and 33 translate together towards the advanced position, being attached by the device 39; the member 33 remains, therefore, in the release position, while the pinions 32 and 52 continue to be disengaged from the corresponding racks 27 and 50, so that they idle;
3. while the shaft 25 continues to rotate, at the advanced position (FIG. 3), the toothing of the pinion 52 begins to engage the rack 50; the members 6 and 33 continue to translate together towards the advanced position, while the pinion 32 continues to idle;
4. when the member 6 reaches the advanced position (FIG. 4), the motor 18 stops; the toothing of the pinion 28 has finished its task and is just disengaged from the rack 27, while the toothing of the pinion 52 continues to engage the rack 50;
5. after having mounted the device 9 on the assembly 1 (FIG. 5), the motor 18 is restarted (via a manual command by the user, or via a signal from a sensor or a switch, e.g. defined by an electrical contact that automatically closes a circuit, when the interface element 14 is mounted on the member 6 and the latter reaches its predefined reference position in the seat 15 of the interface element 14), so that the toothing of the pinion 52, by rotating, acts on the rack 50, overtakes the retention action of the device 39, and causes the member 33 to shift into the engaged position; at the same time, the pinions 28 and 32 idle (so that the rack 27 is free), while the member 6 remains in the advanced position (e.g. held by the friction of the seal 13 against the portion 8a, and/or by a stop system, not illustrated and possibly similar to the device 39);
6. continuing to rotate the shaft 25, and thus the pinion 52, the latter is disengaged from the rack 50 (see FIG. 6, where this step is illustrated in an approximate way), while the member 33 remains in the engaged position, and the pinion 28 continues to idle;
7. at the same time, the toothing of the pinion 32 starts to engage the rack 27 (FIG. 7); at this point, with the pinions 28 and 52 disengaged from the racks 27 and, respectively, 50, the member 6 starts to withdraw due to the action of the pinion 32 to be brought from the advanced position into the operating position (FIG. 8), while the member 33 remains in the engaged position.

Once the operating position is reached, the motor 18 stops, and the user can use the device 9 as normal. Obviously, to disassemble the device 9, these steps are performed in reverse in relation to how they are listed.

As can be seen in FIG. 8, stopping in the above-mentioned operating position preferably corresponds to the abutting of a rear projection 14a of the interface element 14 against the surface 5 of the shell 4. This abutment contributes to limiting the vibrations of the device 9 during use.

The steps listed under reference numbers 6 and 7 could be left out if the advanced and operating positions are the same (in this variant, not illustrated, the assembly 1 would not have any idler gears 29 and 30, the shaft 31, and the pinion 32).

According to an embodiment which is not illustrated, the retention member 33 is an element driven by an actuator mounted inside the member 6. This actuator, therefore, is carried, moving, by the member 6 when acted on by the rack 27. In particular, this actuator is a linear actuator, and the retention member 33 directly defined by the stem of this linear actuator, without intermediate transmissions. In this embodiment, therefore, the transmission 49 (i.e., the rack 50 and pinion 52), and preferably also the guide 38 and the slide 37, are absent, while the shifting of the retention member 33 and the shifting of the member 6 are driven by two actuators or motors that are distinct from each other.

An automatic activation system is preferably provided to make the motor 18 go again, and to retract the member 6 in the operating position, after the above-mentioned actuator has driven the retention member 33 and has, therefore, locked the device 9: in other words, a sensor or a switch, e.g. defined by an electrical contact that closes a circuit, provides a consent signal when the retention member 33 reaches a predefined locking position in the corresponding seat of the interface element 14, and this signal drives the motor 18 again. A similar automatic system preferably causes the activation of the above-mentioned actuator to lock the device 9 when the interface element 14 is mounted on the member 6 in the predefined reference position. Therefore, this type of solution also makes it possible to recognise the correct engagement of the device 9 and to simplify the movement commands, and, potentially, to also manage an anti-pinching function.

In addition, with this embodiment, the pinion 32 and the idler gears 29, 20 become superfluous and may be eliminated if the rotation direction of the motor 18 can be inverted; in fact, in this case, the pinion 28 may always be meshing with the rack 27 and cause the withdrawal of the member 6 from the advanced position towards the operating position (by inverting the rotation direction of the motor 18 in relation to what is set to shift the member 6 towards the advanced position).

From the above, it is clear how the assembly 1 is retractable, inside the dashboard 2, and makes it possible to lock the device 9 simply and securely thanks to the action of the member 33. In particular, it should be clear how the operations for coupling and uncoupling the device 9 are extremely simple since the user does not manually intervene to directly operate the member 33, since this action is motorised.

Furthermore, considering the preferred illustrated embodiment, the fact of using just one motor 18 to drive both the members 6 and 33 makes it possible to have a relatively compact solution.

The use of toothings of gears that have an angular dimension of less than 360° enables the motor to be continuously rotated (clockwise, for example) and makes it possible to phase or adjust the timing when the pinions start to engage and disengage in relation to the racks, as a function of the rotation angle of the shaft 25. In other words, by continuously rotating the motor in a single rotation direction, the parts of the toothings that are needed to achieve the required movement are selectively activated.

In addition, as mentioned above, in order to alternately activate the transmissions clutches or selectors are preferably not used, and the motor 18 is always coupled to these transmissions so that the obtained solution is compact and has a relatively small number of components.

In addition, the embodiment described above is particularly compact. In this embodiment, the retention member 33 is driven by an actuator mounted in the member 6 and is distinct from the motor 18: in this embodiment, as explained above, the transmission 49 is absent and the transmission 19 can be simplified.

From the above, it is clear, finally, how the assembly 1 described can be modified, or variants thereof produced, which do not go beyond the scope of protection of the present invention.

In particular, the member 6 and/or the member 33 could have different shapes and sizes, and/or could be coupled to the device 9 and/or to the interface element 14 in different ways, compared to what is illustrated, by way of example, in the attached figures.

1. A support and holding assembly (1) for a portable electronic device (9), the assembly comprising:
a support structure (3);
a support member (6) that has, at one end, a coupling portion (10), to which said portable electronic device can be coupled, in use, in order to be arranged in a reference position; the support member (6) being movable between a withdrawn rest position and an advanced position in relation to said support structure (3);
a retention member (33), that is carried by said support member (6) and can be moved in relation to said support member (6) between
a) an engaged position, in which the retention member (33) holds, in use, the portable electronic device in the reference position in relation to said support component, and
b) a disengaged position, in which the portable electronic device is free to be coupled to, and uncoupled from, said coupling portion (10);
at least one motor or actuator (18);
a first transmission (19) driven by said motor or actuator (18) in order to shift said support member (6) between the withdrawn rest position and the advanced position.

2. The assembly according to claim 1, further comprising a second transmission (49) to shift said retention member (33) between the engaged position and the disengaged position.

3. The assembly according to claim 2, wherein said second transmission (49) is also driven by said motor or actuator (18).

4. The assembly according to claim 2, wherein at least one of said first and second transmission (19, 49) comprises a rack and pinion drive.

5. The assembly according to claim 4, wherein said first and second transmissions (19, 49) comprise respective rack and pinion drives.

6. The assembly according to claim 2, further comprising a transmission shaft (25) permanently coupled to said first and second transmission (19, 49).

7. The assembly according to claim 6, wherein said first and second transmission (49) are configured so as to shift said retention member (33) between the engaged position and the disengaged position only when said support member (6) is arranged in the advanced position.

8. The assembly according to claim 6, wherein:
said first transmission comprises a first pinion and a first toothing carried by said support member (6);
said second transmission comprises a second pinion and a second toothing (50) carried by said retention member (33);
the first and second pinions comprise corresponding toothed segments arranged in angular positions so that, when said first pinion is disengaged from said first toothing (27), said second pinion meshes with said second toothing (50) so as to cause, by rotation, the movement of said retention member (33).

9. The assembly according to claim 8, wherein said first and second pinions are carried in fixed and coaxial positions on said transmission shaft (25).

10. The assembly according to claim 8, wherein at least one of said first and second toothings (27, 50) is defined by a rack.

11. The assembly according to claim 10, characterised in that said rack extends along a curved trajectory.

12. The assembly according to claim 8, wherein said first transmission (19) comprises:
an additional pinion, and
a pair of idler gears, which transmit and invert a rotary motion between said first pinion and said additional pinion.

13. The assembly according to claim 12, wherein said additional pinion has a toothed segment that engages with said first toothing (27) only when said first and second pinions are disengaged respectively from said first and second toothings.

14. The assembly according to claim 1, comprising an additional motor or actuator carried by said support member (6) and distinct from said at least one motor or actuator (18); said retention member (33) being driven by said additional motor or actuator.

15. A vehicle dashboard, comprising a support and holding assembly (1) for a portable electronic device (9) according to claim 1.
